(19) United States
(12) Patent Application Publication
(10) Pub. No.: US 2007/0070910 A1
(43) Pub. Date: Mar. 29, 2007

(54) Managing OAM packets in a communications network

(75) Inventor: Naftaly Blum, Tel-Aviv (IL)

Correspondence Address: Siemens Corporation;Intellectual Property Department, 170 Wood Avenue South, Iselin, NJ, 08830, US

(73) Assignee: Siemens Aktiengesellschaft

(21) Appl. No.: 11/237,470

(22) Filed: Sep. 28, 2005

(51) Int. Cl. H04L 12/26; H04L 1/00; G01R 31/08

(52) U.S. Cl. 370/241.1; 370/229

(57) ABSTRACT

Managament of an Operation and Maintenance (OAM) packet in a communications network is provided. According to one embodiment, a network device in a Multiprotocol Label Switching (MPLS) network for providing a uniform distribution of OAM is provided. The network device comprises of a memory unit and a hardware unit. The memory unit having an improved data table with an active record. The hardware unit coupled to the memory unit. The hardware unit operable to calculate an interval based on a number of active records in the improved data table, scan the active record generally within the interval, and form an OAM packet based on the active record.

### FIELD OF THE INVENTION

The present invention relates to a communications network, and more particularly, to managing Operation and Maintenance (OAM) packets in a communications network.

### BACKGROUND

Multiprotocol Label Switching (MPLS) is an architecture for fast packet switching and routing and is used in communications networks. MPLS is called multiprotocol since it is independent of layer-2 and layer-3 protocols such as Asynchronous Transport Mode (ATM), frame relay, and Internet Protocol (IP). Operation and Maintenance (OAM) functions, such as performance monitoring and failure detection, are facilitated in the network by OAM packets. The OAM packets are periodically transmitted to circuits in the network wherein the circuits represent a connection, such as a virtual connection. Thousands of circuits, which may be dynamically added or removed, exist in a typical network

There exists a need to provide an improved way to manage transmitting OAM packets in communications network.

### SUMMARY OF THE INVENTION

In one aspect of the present invention, a network device in a Multiprotocol Label Switching (MPLS) network for providing a uniform distribution of Operation and Maintenance (OAM) is provided. The network device comprising a memory unit and a hardware unit. The memory unit having an improved data table with an active record. The hardware unit coupled to the memory unit. The hardware unit operable to calculate an interval based on a number of active records in the improved data table, scan the active record generally within the interval, and form an OAM packet based on the active record.

In another aspect of the present invention, a software for scanning a record within a time interval for a Multiprotocol Label Switching (MPLS) network is provided device. The software embodied in at least one computer-readable medium and when executed by one or more processors operable to determine a number of active records in an improved data table to scan in a period, the active record having a circuit information, determine the period for scanning the determined number of active records, calculate the interval between the scans; and scan an active record in the improved data table generally within the interval.

In yet another aspect of the present invention, a method for managing a time interval for transmitting an Operation and Maintenance (OAM) packet in a communications network is provided. The method comprising determining a number of OAM packets to transmit in a period, determining the period for transmitting the number of OAM packets, calculating the interval based on the number of OAM packets and the period, and transmitting an OAM packet generally within the interval.

### BRIEF DESCRIPTION OF THE DRAWINGS

The above mentioned and other concepts of the present invention will now be described with reference to the drawings of the exemplary and preferred embodiments of the present invention. The illustrated embodiments are intended to illustrate, but not to limit the invention. The drawings contain the following figures, in which like numbers refer to like parts throughout the description and drawings wherein:

FIG. 1 illustrates an exemplary prior art schematic diagram of a data table for storing records pertaining to Operation and Maintenance (OAM) packets;

FIG. 2 illustrates an exemplary prior art schematic diagram of OAM packet transmission intervals;

FIG. 3 illustrates an exemplary flow diagram for managing a time interval for transmitting OAM packets in accordance with the present invention;

FIG. 4 illustrates an exemplary schematic diagram of an improved data table for providing a uniform distribution of OAM packets in accordance with the present invention;

FIG. 5 illustrates an exemplary schematic diagram of OAM packet transmission in accordance with the present invention; and

FIG. 6 illustrates an exemplary schematic diagram of a network device in a Multiprotocol Label Switching (MPLS) network for providing a uniform distribution of OAM packets in accordance with the present invention.

### DETAILED DESCRIPTION OF THE INVENTION

The invention described herein may employ one or more of the following concepts. For example, one concept relates to a time interval for transmitting an Operation and Maintenance (OAM) packet in a communications network. Another concept relates to transmitting the OAM packet in a Multiprotocol Label Switching (MPLS) network. Another concept relates to recalculating the interval if a period changes. Another concept relates to recalculating the interval if a number of OAM packets to be transmitted during the period changes. Another concept relates to transmitting the OAM packet generally within the interval, substantially within the interval, or at the interval. Still another concept relates to scanning an improved data table record generally within the interval, substantially within the interval, or at the interval. Yet another concept relates to storing an active record in an improved data table wherein the OAM packet to be transmitted is based on the active record.

The present invention is disclosed in context of an OAM packet being transmitted in an MPLS communications network. The principles of this invention, however, are not limited to a MPLS communications network but may be applied to any communications network having OAM packets. Also, while the present invention is disclosed in terms of an improved data table being a link list of active records having a head pointer and a tail pointer, the invention, however, is not limited to a link list having a head pointer and a tail pointer or moreover to a link list. The principles of this may be applied to any suitable data structure that may include active records, wherein a number of active records may be determined and wherein that the active records may be scanned generally within an interval, substantially within the interval or at the interval. For example, the link list might not have a tail pointer or the data table may be a cache.

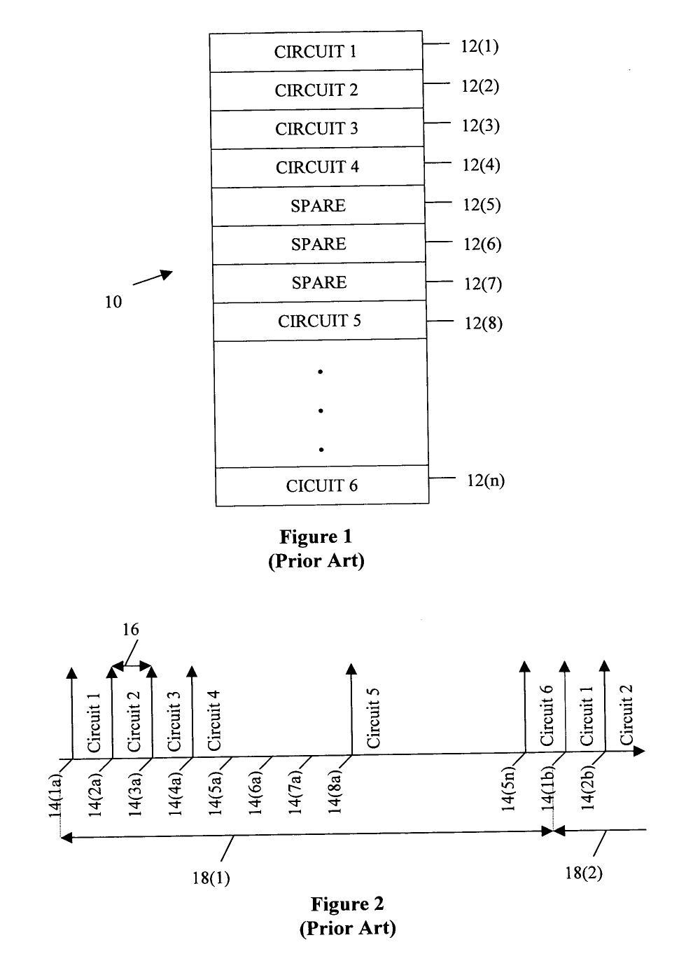

Referring to FIG. 1, an exemplary prior art schematic diagram of data table 10 for storing records pertaining to OAM packets is provided. The data table 10 includes n number of records 12(1) . . . 12(n). The record 12 may store information about a circuit, such as a circuit-identification. Additionally, the record 12 may store activity indication fields to identify what information should go into the OAM packet. A record having circuit information is referred to as “active” and a record not having circuit information is referred to as “spare”.

In the prior art diagram illustrated in FIG. 1, spare records 12(5), 12(6), and 12(7) exist between the active records 12(4) and 12(8). A record 12 may be spare if it has not been administered to include circuit information or if the circuit information has been removed.

Referring now to FIGS. 1 and 2, an exemplary prior art schematic diagram of OAM packet transmission intervals is provided. OAM packets are formed based on the information provided in an active record 12(1), 12(2), 12(3), 12(4), 12(8), and 12(n). The OAM packets are transmitted at a fixed time 14 over a period 18. For example, an OAM packet based on record 12(1) is transmitted at a fixed time 14(1a) and then again at a fixed time 14(2a). The data table 10 is scanned at a rate of a period 18 divided by n, wherein the period 18 is the time allotted for transmitting an OAM packet for every record 12 in the data table 10, and n is the number of records 12 in the data table 10. The rate the data table 10 is scanned provides an interval 16 between which an OAM packet may be transmitted.

This method results in uneven transmissions loads. For example, during times 14(5a), 14(6a), and 14(7a) no transmissions are sent since records 12(5), 12(6), and 12(7) are spare. Spare records 12(5), 12(6), and 12(7) in data table 10 cause bursts in the transmission that require high communication bandwidth and may result in transmission bottlenecks.

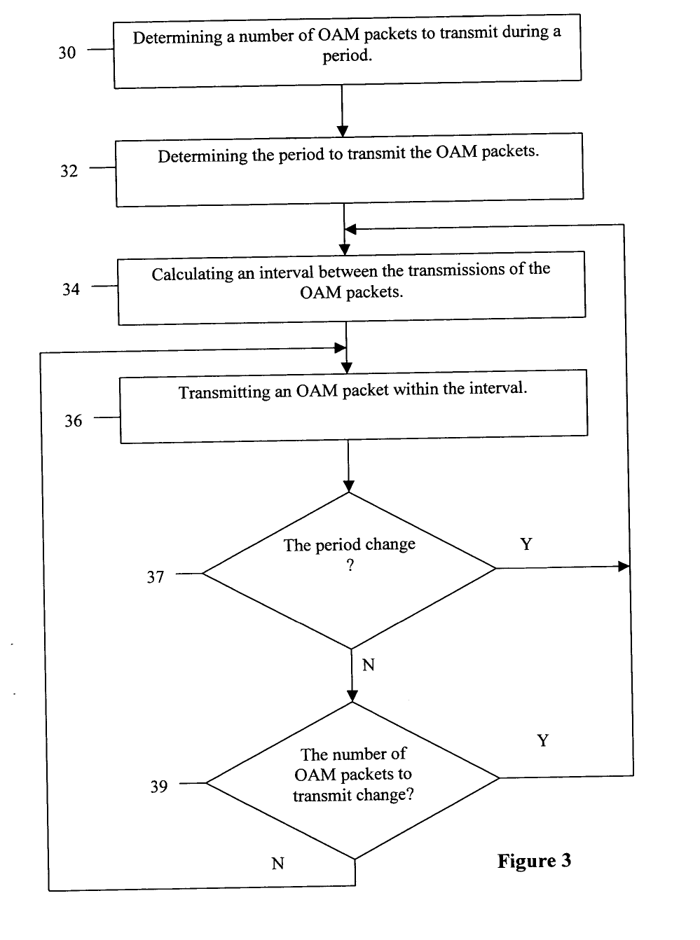

Now referring now to FIG. 3, an exemplary flow diagram for managing a time interval for transmitting OAM packets in accordance with the present invention is provided. Software, hardware, or combinations thereof may provide the activities represented in the flow diagram. Also, the activities may be included in a network device, e.g. Label Switch Router (LSR) or Label Edge Router (LER), in the communications network.

The number of OAM packets to transmit in the period is determined 30. The number of OAM packets is preferably the number of active records pertaining to an OAM packet. Also, the period for transmitting the OAM packets is determined 32. The period may be, for example, an administrable or configurable value. The period is the length of time to transmit the number of OAM packets determined above. An interval may be calculated as the period divided by the number of OAM packets to transmit 34. An OAM packet is transmitted generally within the interval 34. The term “generally within the interval” means a time from 0 to two times the calculated interval. However, the OAM packet may be transmitted substantially within the interval, wherein the term “substantially within the interval” means a time from ½ the calculated interval to 1½ times the interval. Preferably, the OAM packet is transmitted “at the interval”, which means a time equal to the interval. If the period changes, the interval is recalculated 37. Also, if the number of OAM packets to transmit increases or decrease, the interval is recalculated 39

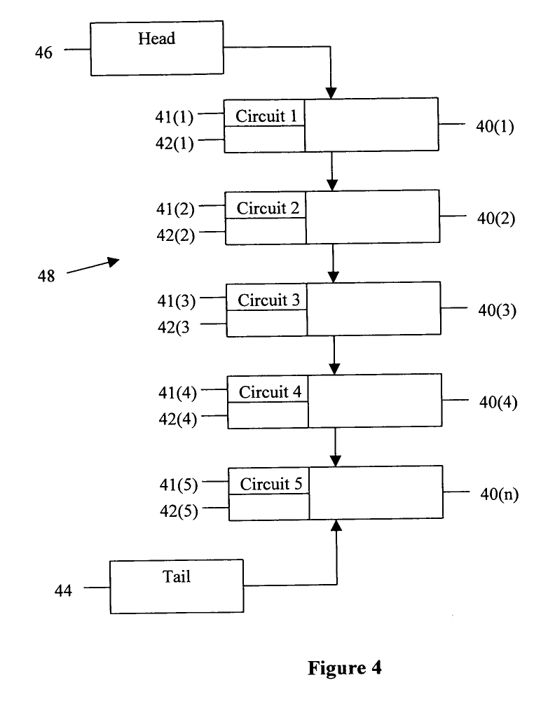

Now referring to FIG. 4, an exemplary schematic diagram of an improved data table 48 for providing a uniform distribution of OAM packets in accordance to the present is provided. The exemplary improved data table 48, in FIG. 4, is a link list and includes a head pointer 46, tail pointer 44, and n active records 40. OAM packets are formed based on the active records 40 in the improved data table 48. Also, the number of OAM packets to transmit in a period may be based on the active records 40 in the improved data table 48. Therefore, the interval is the number of active records 40 divided by the period to scan the active records 40. The uniform distribution of OAM packets is when the active records 40 are scanned generally within the interval, substantially within the interval, or at the interval. Preferably the active records 40 are scanned at the interval. The scan rate of the records 40 influences the transmission of the OAM packets to be transmitted preferably generally within the interval, more preferably substantially within the interval, and most preferably at the interval.

The record 40 includes information about a circuit 41, such as a circuit-identification. The record 40 may store an activity indication field 42 to identify what information should go into the OAM packet. Those skilled in the art would recognize that a default activity indication field may be used if the activity indication field is not stored in the record 40. Additionally, when the improved data table 48 is a link list as illustrated, the record 40 includes a pointer to the next record. A pointer may be any suitable value to indicate a record 40, for example the pointer may be an address or an index. The last record 40(n) in the link list has an end-of-list indicator, such as a NULL. However, those skilled in the art would realize that other suitable end-of-list indicator may be used such as −1.

The head pointer 46 may point to the record that was last added to the list. For the example in FIG. 4, the head pointer 46 points to record 40(1). If there are no records in the list, the head pointer 46 uses the end-of-list indicator.

The tail pointer 44 points to the first record in the list. For the example in FIG. 4, the tail pointer 44 points to record 40(n). Like the head pointer 46, if there are no records in the list, the tail pointer 44 uses the end-of-list indicator.

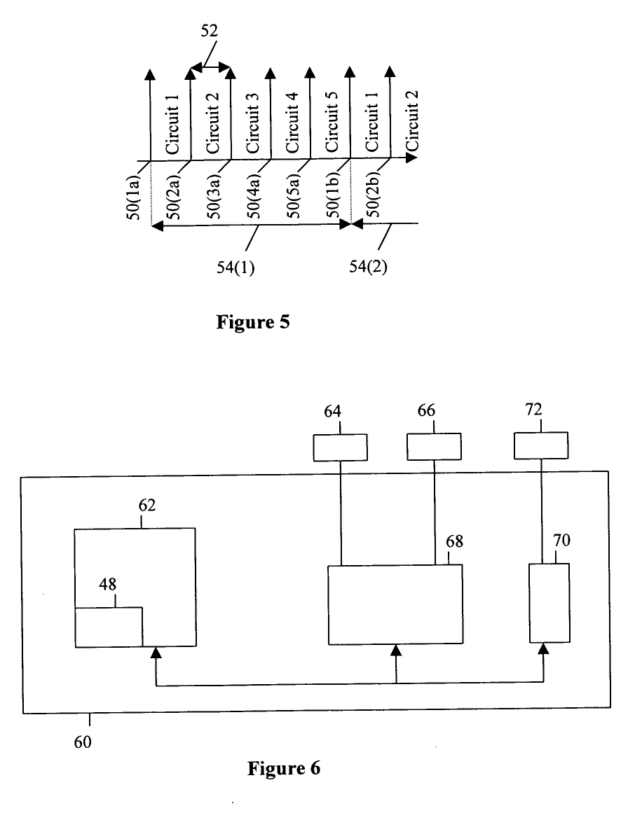

Now referring to FIGS. 4 and 5, an exemplary schematic diagram of OAM packet transmission in accordance to the present invention is provided. The interval 22 of the in the is not fixed on a number of records 12, the records being active and/or spare, as shown in FIGS. 1 and 2. In contrast, the interval 22 is based on a number of active records wherein an active record 40 may be dynamically added or removed to or from the improved data table 48. An active record 40 is scanned generally within the interval, substantially within the interval, or at the interval. An OAM packet is formed based on the active record 40 and is transmitted at a time 50 which us generally within the interval 22, substantially within the interval 22, or at the interval 22. Thus, a more uniform distribution of OAM packets is achieved since times are not reserved for spare records. For example, the OAM packet based on record 40(1) is transmitted at time 50(1a) and again at 50(1b).

Now referring to FIGS. 4 and 6, and exemplary schematic diagram of a network device 60 in an MPLS network for providing a uniform distribution of OAM packets in accordance with the present invention is provided. The exemplary network device 60 includes a hardware unit 68, a memory unit 62 and a processor 70. The exemplary network device 60 is coupled to an input interface 64, output interface 66, and user interface 72. The term “coupled” refers to any direct or indirect communication between two or more elements in network device 60, whether or not those elements are in physical contact with one another. The network device 60, e.g. LSR, or LER, is capable of sending and receiving traffic and capable of sending OAM packets. “Traffic” refers to packets of data or voice pertaining to a network subscriber.

The memory unit 62 includes the improved data table 48. The memory unit 62 is a hardware device, such as a cache, a Random Access Memory (RAM), a magnetic disk, and the like, that is capable of storing and retrieving information. Preferably, the memory unit 62 is capable of high-speed storage and retrieval.

The processor, such as a central processing unit or microprocessor, is coupled to a user input interface 72. The user interface 72 allows a craftsperson of the communications network to administer the records of the improved data table. Administering a record refers to changing a record as well as dynamically adding or removing a record to or from the improved data table 48.

The hardware unit 68 is coupled to the memory unit 62 and the processor 70. Additionally, The hardware unit 68 is coupled to an input interface 64 and an output interface 66. The hardware unit 68 is a device, such as a Field Programmable Gate Array (FPGA), an Application Specific Integrated Circuit (ASIC), and the like, that calculates the scan rate as described in the foregoing section. Additionally, the hardware unit 68 may determine the number of active records in the improved data table 48, generate OAM packets using the active records 40 in the improved data table 48, merging the OAM packets into the traffic, and update the improved data table 48 based on an input from a craftsperson. Traffic may be received traffic directly or indirectly from the input interface 64 and sent directly or indirectly to the output interface 66.

Those skilled in the art would recognize that the network device 60 may be embodied with other configurations. For example, the hardware unit 68 may be coupled to the user input 72 without the aid of the processor 70.

While the invention has been described in terms of a certain preferred embodiment and suggested possible modifications thereto, other embodiments and modifications apparent to those of ordinary skill in the art are also within the scope of this invention without departure from the spirit and scope of this invention. Thus, the scope of the invention should be determined based upon the appended claims and their legal equivalents, rather than the specific embodiments described above.

1. A network device in a Multiprotocol Label Switching (MPLS) network for providing a uniform distribution of Operation and Maintenance (OAM), comprising:
a memory unit having a improved data table with an active record; and
a hardware unit coupled to the memory unit, the hardware unit operable to:
calculate an interval based on a number of active records in the improved data table,
scan the active record generally within the interval, and
form an OAM packet based on the active record.

2. The network device according to claim 1, wherein the hardware unit is coupled to an input interface for receiving traffic and an output interface for sending traffic, and wherein the OAM packet formed is transmitted generally within the interval.

3. The network device according to claim 2, wherein the packet formed is transmitted substantially within the interval or at the interval.

4. The network device according to claim 3, further comprising a processor coupled to the hardware unit and coupled to a user input, the user input allowing a craftsperson to administer the improved data table.

5. The network device according to claim 4, wherein the active record is scanned substantially within the interval or at the interval.

6. The network device according to claim 5, wherein the network device is Label Edge Router or a Label Switch Router.

7. A software for scanning a record within a time interval for a Multiprotocol Label Switching (MPLS) network device, the software embodied in at least one computer-readable medium and when executed by one or more processors operable to:
determine a number of active records in an improved data table to scan in a period, the active record having a circuit information;
determine the period for scanning the determined number of active records;
calculate the interval between the scans; and
scan an active record in the improved data table generally within the interval.

8. The software according to claim 7, wherein the active record is scanned substantially within the interval or at the interval.

9. The software according to claim 7, further operable to form an Operation and Maintenance (OAM) packet based on the active record scanned.

10. The software according to claim 9, further operable to transmit the OAM packet in a time selected from the group consisting of: generally within the interval, substantially within the interval, and at the interval.

11. The software according to claim 10, wherein the improved data table is a link list of active records.

12. The software according to claim 7, further comprising recalculating the interval between the OAM packets if the period changes or of the number of active records change.

13. A method for managing a time interval for transmitting an Operation and Maintenance (OAM) packet in a communications network, comprising:
determining a number of OAM packets to transmit in a period;
determining the period for transmitting the number of OAM packets;
calculating the interval based on the number of OAM packets and the period; and
transmitting an OAM packet generally within the interval.

14. The method according to claim 13, further comprising recalculating the interval between the OAM packets.

15. The method according to claim 13, further providing a link list having a list of active records.

16. The method according to claim 15, wherein the number of OAM packets to transmit in the period is based on a number of active records in the list.

17. The method according to claim 15, wherein the active record includes information about a circuit.

18. The method according to claim 17, wherein the active record includes activity indication fields.

19. The method according to claim 13, wherein the OAM packets are transmitted substantially within the interval or transmitted at the interval.
